(19) United States
(12) Patent Application Publication
(10) Pub. No.: US 2007/0137582 A1
(43) Pub. Date: Jun. 21, 2007

(54) Fluid handling assemblies

(75) Inventor: David Boast, Wiltshire (GB)

Correspondence Address: MCGARRY BAIR PC, 32 Market Ave. SW, SUITE 500, GRAND RAPIDS, MI, 49503, US

(73) Assignee: AVON POLYMERS PRODUCTS LIMITED, Bradford on Avon, Wiltshire (GB)

(21) Appl. No.: 10/595,007

(22) PCT Filed: Jun. 11, 2004
(86) PCT No.: PCT/GB04/02507

§ 371 Date: Feb. 8, 2007

(30) Foreign Application Priority Data
Jun. 12, 2003 (GB) 0313624.9
Nov. 21, 2003 (GB) 0327202.8

(51) Int. Cl. A01J 5/00

(52) U.S. Cl. 119/14.54

(57) ABSTRACT

In a fluid handling assembly, such as an animal milking apparatus, it is necessary for an elastic tube (1) to be fitted to, and removed from, a spigot (3). The prevent the tube (1) necking down when an attempt is made to remove it, a sleeve (9) is provided between the spigot (3) and the tube (1). The internal diameter of the sleeve (9) is the same as the outer diameter of the spigot (3) so that the sleeve (9) is slidable on the spigot (3) to enable the sleeve and hence the tube (1) to be removed from the spigot. The sleeve (9) may have a flange (10) or even a collar (19) to enable it to be gripped easily.

This invention relates to fluid handling assemblies where a tube receives a spigot, and to a quick release mechanism for separating the tube and spigot. The invention is applicable to, but not limited to, assemblies in animal milking apparatus.

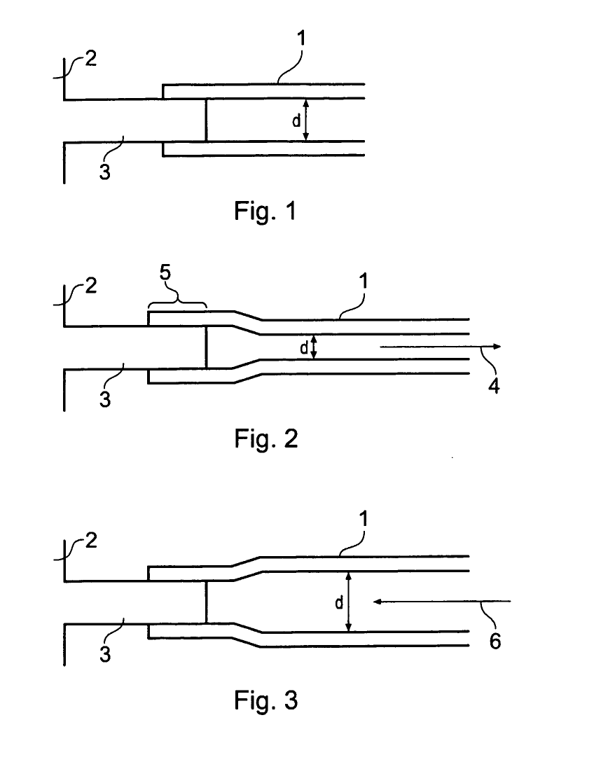

In a fluid handling assembly, it may be necessary for a tube to be fitted to a spigot extending from a vessel. Usually, the tube is elastic in the radial and axial sense. Typically, the tube is made of rubber. In this arrangement, shown in cross-section in FIG. 1, fluid can pass through the tube 1 of diameter d from/into the vessel 2 via the spigot 3. The tube may distend radially to accommodate the spigot, causing the diameter of the tube to increase.

The tube may need to be detached from the spigot, for example when the assembly is to be cleaned or a part of the assembly replaced. The elastic nature of the tube, however, can present difficulties during detachment of the tube from the spigot. The usual way to remove the tube is to pull the tube axially away from the spigot, as shown in cross section in FIG. 2. The tube 1 stretches axially as the pulling force 4 is applied and a radial

Therefore, at its most general, the present invention proposes an assembly where a spigot is received axially in an end of a tube, there being a sleeve of rigid material located concentrically between the spigot and the tube. The sleeve serves to separate a portion of the tube from the spigot.

The present invention offers an advantage of providing a means to allow quick-release of the tube from the spigot, with a minimum of effort required. The quick-release means can avoid extensive stretching of the tube.

According to a first aspect of the invention, there may be provided an assembly comprising a vessel having at least one spigot extending therefrom; a tube through which fluid can pass, the tube being elastic in the axial and radial sense; and a sleeve of rigid material having substantially the same inner diameter as the outer diameter of the spigot; wherein the spigot is axially received in a neck of the tube, and the sleeve is located concentrically between the spigot and the tube so that the sleeve is slidable axially on the spigot and at least a portion of the tube extending from the neck is separated from the outside of the spigot by the sleeve.

When the tube is to be removed from the spigot, the sleeve is gripped and the sleeve and neck of the tube pushed axially, away from the vessel, to separate the tube from the spigot. The necking down effect can therefore be eliminated.

When the neck of the tube is pushed axially, ‘barrelling’ (the opposite effect to ‘necking down’) is observed, as the axial length of the tube is compressed and the diameter of the tube increases accordingly. Axially pushing the neck of the tube increases the barrelling effect, reducing the gripping tendency of the tube on the spigot and therefore reducing the effort required to disengage the tube from the spigot.

The sleeve may separate from the spigot the whole of the section of the tube that accommodates the spigot. Alternatively, the sleeve may separate from the spigot just a portion of the section of the tube that accommodates the spigot, so that an adjacent section of the tube contacts the spigot directly.

Preferably, the tube does not receive the full axial length of the sleeve, so a section of the sleeve protrudes axially from the tube. This section of the sleeve may be gripped to allow the sleeve and tube to be pushed axially relative to the spigot.

Preferably, the protruding section of the sleeve includes a flange extending from the section. The flange may extend from the rim of the sleeve. The flange is not received in the bore of the tube and provides a surface extending perpendicularly or obliquely from the axis of the sleeve, against which a pushing force can be applied to slide the sleeve (and the tube) off the spigot. During axial movement of the sleeve along the spigot, the flange abuts the neck of the tube, enhancing axial compression of the tube and the resulting barrelling effect.

Additionally or alternatively, a collar is mounted on the flange extending perpendicularly or obliquely from the axis of the sleeve. The collar extends circumferentially around the sleeve, and also around the liner when the liner is mounted on the sleeve. The collar thus provides a means for gripping the sleeve from outside the liner. The collar is preferably cylindrical, although tapered shapes may also be used. Other shapes are also possible, provided the inside of the collar is spaced from but conforms generally to the sleeve. The collar provides a gripping means by which a pushing force may be applied more easily to slide the sleeve (and the tube) off the spigot. The collar has the additional advantage of protecting the neck of the tube and of preventing the section of tube located along its length, from being unintentionally clamped to the spigot and/or sleeve.

In a development of this feature, the end of the liner may be shaped so as to conform to the space between the sleeve and the collar, for better abutment of the flange of the sleeve on the end of the liner, to assist with the removal of the liner. However, the interior of the collar needs to be sufficiently large to accommodate the barrowing effect of the liner.

Additionally, or alternatively, the end portion of the sleeve located axially furthest in the bore of the tube may be chamfered. The outer surface of the sleeve may incline towards the axis of the sleeve to provide a gradient over the depth of the sleeve wall that assists insertion of the sleeve in the tube during assembly.

The sleeve may include, at the end located furthest inside the bore of the tube, a tapered portion. The tapered portion is formed by the wall of the sleeve inclining towards the axis of the sleeve to narrow the opening of the sleeve. The tapered portion may allow easier insertion of the sleeve into the tube.

Additionally or alternatively, the sleeve may include at least one slit in the wall of the sleeve. The slit may extend from the rim of the sleeve, preferably the rim located axially furthest inside the bore of the tube, and extend substantially axially along a section of the sleeve. There may be a series of slits spaced around the circumference of the sleeve. The spacing of the slits may be approximately even around the circumference of the sleeve.

If the sleeve includes a tapered portion at one end, a slit or slits may extend from the narrowed opening of the sleeve.

The slits may allow the radial gripping force from the section of the tube that receives the spigot to be transferred through the sleeve to the spigot, forming a tight fit between the sleeve and the spigot. Slits may be useful in an arrangement where the sleeve separates from the outside of the spigot the entire section of the tube that accommodates the spigot.

The sleeve is made of any rigid material. Preferably, the sleeve is made of plastic.

A section extending from the neck of the tube may be modified to include a widened bore relative to the rest of the tube, suitable for receiving the sleeve. The modification may include a narrowing of the walls of the tube or a flaring of the tube. The modification may allow the sleeve to be received in the neck of the tube without the tube expanding radially, reducing the residual hoop tensile strain and associated problems such as tube cracks.

Ideally the axial length of the widened bore of the tube is less than the axial length of the sleeve. The inside surface of the widened section of the tube may, at the boundary between the widened and non-widened sections, incline relative to the axis of the tube. The incline may provide a smooth gradient between the widened and non-widened sections. The inclined surface may abut a chamfered portion on the sleeve.

A section of bore extending from the neck of the tube may be provided with formations that interlock with formations on the sleeve when the sleeve is inserted axially in the tube. The interlocking formations may be a bayonet fitting. The modified tube and sleeve may be part of a kit for a particular diameter spigot, which allows accommodation of the sleeve in the tube without radial stretching of the tube in the section that accommodates the sleeve. The sleeve may be fixed inside the neck of the tube so that the tube and the sleeve form a single piece.

The assembly described above may be, for example, part of animal milking apparatus. The vessel may be a claw piece that comprises a housing with at least one spigot. The tube may be claw tube, known in the art as a ‘liner’. The liner, when threaded onto the spigot, allows milk to be fed into the claw piece and/or drained from the claw piece.

According to a second aspect of the invention, there may be provided a method of assembling the assembly of the first aspect of the invention, comprising:

inserting a spigot into the sleeve of rigid material, and inserting the sleeve and spigot into the neck of the tube; or

inserting the sleeve of rigid material into the neck of the tube and inserting the spigot into the sleeve; such that at least a portion of the tube extending from the neck is separated from the spigot by the sleeve.

The fluid handling apparatus may be animal milking apparatus.

Embodiments of the present invention will now be described in detail, by way of example only, with reference to the accompanying drawings, in which:

FIG. 1 shows in cross section a rubber tube attached to a spigot, and has already been described;

FIG. 2 shows in cross section necking down of the rubber tube when an axial force stretches the tube, and has already been described;

FIG. 3 shows in cross section barrelling of the rubber tube as a force axially compresses the tube, and has already been described;

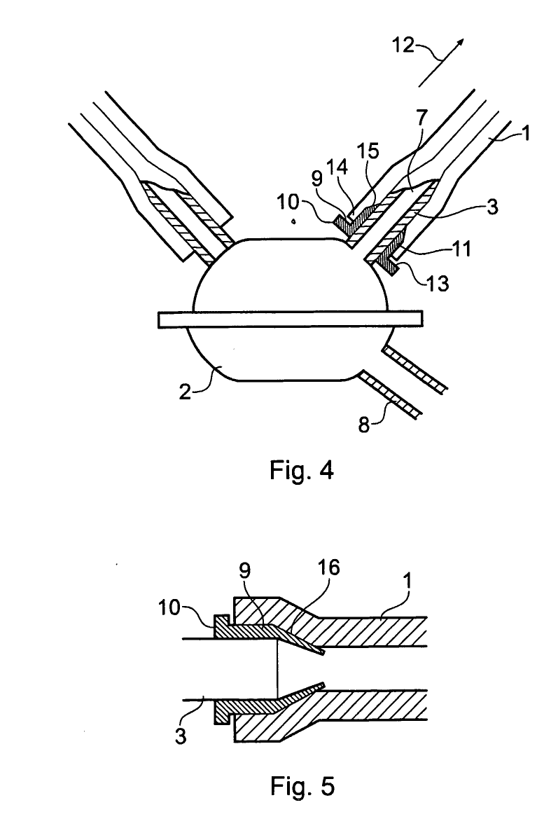

FIG. 4 shows in cross section an animal milking apparatus incorporating an assembly of the present invention;

FIG. 5 shows in cross section an assembly of the present invention, where the sleeve includes a tapered portion; and

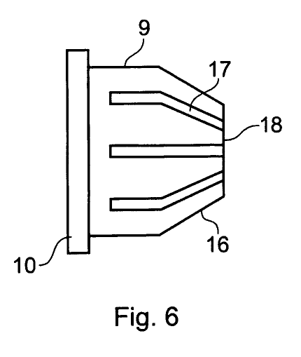

FIG. 6 shows from the side as sleeve of an assembly of the present invention where the sleeve includes slits and a tapered portion.

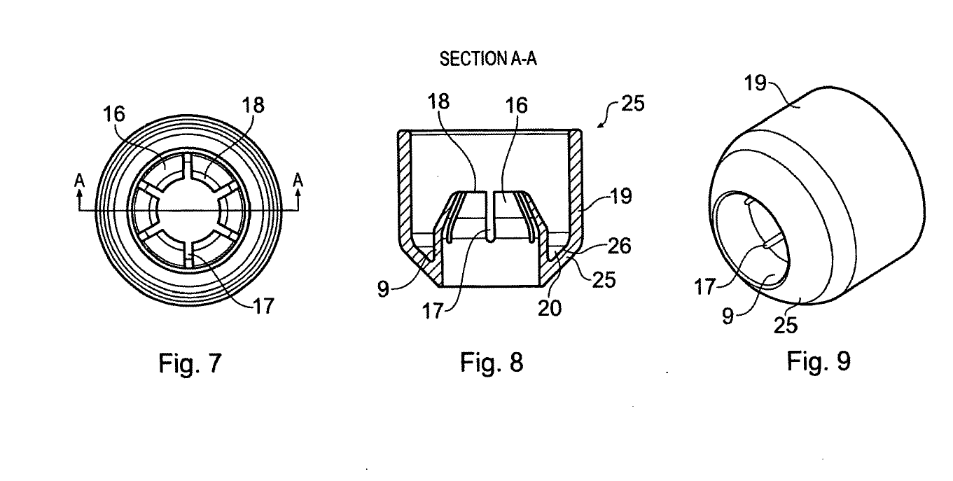

FIG. 7 shows along its axis an embodiment of the present invention.

FIG. 8 shows in cross-section, through A-A shown in FIG. 7, an embodiment of the present invention where the sleeve includes slits, a tapered portion and the flange forms a sheath.

FIG. 9 shows an embodiment of the present invention in perspective.

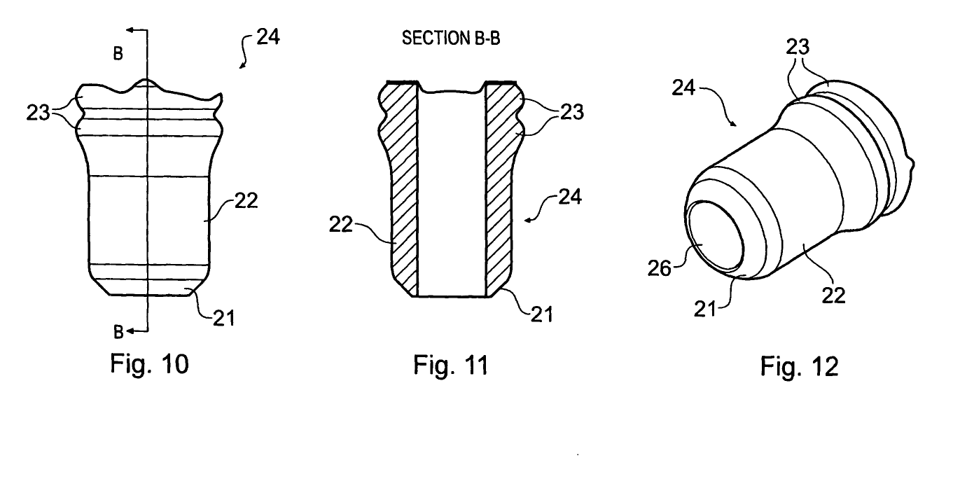

FIG. 10 is a side view of an embodiment of the present invention, showing an end-piece of a liner, having a chamfered region at one end.

FIG. 11 is a cross-section view through B-B of the liner end-piece in FIG. 10.

FIG. 12 is a perspective view of the liner end-piece.

An animal milking apparatus includes, as shown in FIG. 4, a claw piece 2 having a spigot or spout 3 that is inserted into a liner 1. The spigot 3 has an opening 7 lying in an oblique plane to the axis of the spigot. The claw piece also has an outlet conduit 8. Milk receiving means, not shown, sends milk through liner 1 into claw piece 2.

A sleeve, indicated at 9, and possibly of plastic material, sits concentrically between the spigot 3 and a portion of the tube 1 extending from the neck of the tube. The sleeve includes a flange 10, extending from the sleeve rim, lying outside of the tube 1. At the opposing rim of the sleeve 9, there is a chamfered region 11, which allows easy insertion of the sleeve into the tube during assembly.

The sleeve 9 provides a quick release facility for the liner 1. Pushing the flange 10 of the sleeve 9 in the axial direction indicated at 12, slides the sleeve axially along the spigot 3, away from the claw piece 2. A barrelling effect is created in the liner as the liner is axially compressed. The surface 13 of the flange abuts the neck of the liner 1, axially compressing the liner 1 and enhancing the barrelling effect.

The liner 1 can therefore be removed quickly from the spigot 3 with a minimal amount of effort and no stretching of the liner 1.

The liner 1 may include a section with a widened bore, as shown in FIG. 4. The widened bore extends from the neck of the liner 1, provided by narrowed liner walls 14. The widened bore also includes inclined surfaces 15 against which the chamfered surfaces 11 of the sleeve 9 may abut.

The sleeve may be provided with a tapered portion, as shown in FIG. 5 at 16. In this arrangement, the sleeve 9 sits at the end of the spigot 3. The tapered portion is useful for introducing the sleeve into the liner 1, particularly if the diameter of the bore of the tube is significantly less than the outside diameter of the sleeve.

The sleeve may be provided with at least one slit. As shown in FIG. 6, slits 17 extend axially from the narrowed opening of the sleeve 18. In the figure, the slits 17 are evenly spaced around the circumference of the sleeve. Slits may be provided on a sleeve with no tapered portion.

A second embodiment of the invention will now be described with reference to FIGS. 7 to 12. This embodiment is a modification of the first embodiment, and corresponding parts will be indicated by the same reference numerals. However, in this second embodiment there is a collar which extends circumferentially around the sleeve 9 so that the liner fits between the sleeve and the collar, and the collar thus provides a surface for gripping the assembly.

Thus, as shown in FIGS. 7, 8 and 9, the sleeve 9 is similar to that shown in FIG. 6, but the flange 25 (corresponding to the flange 10 in FIG. 6) forms a frustocone which extends from the rest of the sleeve in the direction of the tapered portion 16, and the collar 19 then extends from the end of that flange. Thus, the flange 25 and the collar 19 form a barrel around the sleeve 9, with an inward taper where that barrel joins the rest of the sleeve.

In the embodiment of FIGS. 7 to 9, the liner fits onto the sleeve 9, to lie within the collar 19. Thus, when the resulting assembly is mounted on a spigot of a claw piece, as in FIG. 2, the collar provides a surface to enable the use to grip the collar, to pull the sleeve off the spigot. This provides an advantage over the first embodiment, in that it is not always easy to grip the flange 10.

In a development of this embodiment, the liner is shaped so as more closely to fit into the space defined by the sleeve, flange and collar. Thus, as shown in FIGS. 10 to 12, the liner 24 has a chamfered end to define a surface 21 which is inclined relative to the access of the liner. Then, when the liner is mounted on the sleeve, the chamfered end of the liner 24 fits between the sleeve and the collar so that its surface 21 abuts against the inner surface 26 of the flange 25.

FIGS. 10 to 12 also show that the liner may have ribs 23 spaced from the surface 21. However, a cylindrical part 22 of the liner 24 shaped to be received within the collar and thus needs to be sufficiently long that the ribs 23 do not interfere with the collar 19.

Thus the sleeve 9 provides a quick release facility for the liner 24, and the collar 19 provides a convenient gripping means to push the sleeve and liner 24 axially towards the end of the spigot 3 not connected to the claw 2. The chamfered region 21 of the liner 24 abuts the angled surface 26 of the flange 25, and the barrelling effect is accommodated by the radial separation of the liner 24 and the sheath 19 as the liner 24 and sleeve 9 are removed from the spigot 3. The liner 24 can therefore be removed quickly from the spigot 3, with a minimal amount of effort and no stretching of the liner 25.

1. An assembly for an animal milking apparatus comprising a vessel having at least one spigot (3) extending therefrom; a tube (1) through which fluid can pass, the tube (1) being elastic in the axial and radial sense;
characterized in that:
the apparatus further included a sleeve (2) of rigid material having substantially the same inner diameter as the outer diameter of the spigot (3); the spigot (3) being axially received in a neck of the tube (1), and the sleeve (9) being located concentrically between the spigot (3) and the tube (1) so that the sleeve (9) is slidable axially on the spigot (3) and at least a portion of the tube (1) extending from the neck is separated from the outside of the spigot (3) by the sleeve (9).

2. An assembly according to claim 1, wherein a—part of the sleeve (9) projects from the tube (1).

3. An assembly according to claim 2, wherein said part of the sleeve (9) has a projecting flange (10,25).

4. An assembly according to claim 3, having a collar (19) extending from the flange (25), the collar (19) extending circumferentially around the sleeve (9) and around the tube (1) so that at least the neck of the tube (1) is enclosed by the collar (19).

5. An assembly according to claim 4, wherein the collar (19) is cylindrical.

6. An assembly according to claim 4, wherein the flange (25) extends obliquely from the sleeve (9), and the end (21) of the neck of the tube (1) is tapered to conform to the flange (25).

7. An assembly according to claim 1, wherein the end part (16) of the sleeve (9) axially furthest into the tube (1) is chamfered.

8. An assembly according to claim 1, wherein the end part (16) of the sleeve (9) axially furthest into the tube (1) is inclined towards the axis of the sleeve (9).

9. An assembly according to claim 1 wherein the sleeve (9) has at least one slit (17) therein.

10. An assembly according to claim 7, wherein the at least one slit (17) extends from the end (18) of the sleeve (9) axially furthest into the tube (1).

11. An assembly according to claim 1, wherein the tube (1) has a bore (14) at one end thereof into which the sleeve (9) is received, which bore (14) is wider than the rest of the tube.

12. An assembly according to claim 11, wherein the axial length of the bore (14) is less than the axial length of the sleeve (1).

13. An assembly according to claim 1, wherein the tube (1) is provided with formations which interlock with corresponding formations on the sleeve (9).

14. A method of assembling an assembly for an animal milking apparatus, the assembly comprising a vessel having at least one spigot (3) extending therefrom; a tube (1) through which fluid can pass, the tube (1) being elastic in the axial and radial sense;
characterized in that:
the apparatus further included a sleeve (2) of rigid material having substantially the same inner diameter as the outer diameter of the spigot (3); the spigot (3) being axially received in a neck of the tube (1), and the sleeve (9) being located concentrically between the spigot (3) and the tube (1) so that the sleeve (9) is slidable axially on the spigot (3) and at least a portion of the tube (1) extending from the neck is separated from the outside of the spigot (3) by the sleeve (9), the method comprising:
inserting the spigot (3) into the sleeve (9) of rigid material, and inserting the sleeve (9) and (3) into the neck of the tube (1); or
inserting the sleeve (9) of rigid material into the neck of the tube (1) and inserting the spigot (3) into the sleeve (9); such that at least a portion of the tube (1) extending from the neck is separated from the spigot (3) by the sleeve (9).
